(19) United States
(12) Patent Application Publication
(10) Pub. No.: US 2011/0009221 A1
(43) Pub. Date: Jan. 13, 2011

(54) SILENT CHAIN TRANSMISSION SYSTEM

(75) Inventor: Toshitaka OGO, Osaka (JP)

Correspondence Address: HOWSON & HOWSON LLP, 501 OFFICE CENTER DRIVE, SUITE 210, FORT WASHINGTON, PA, 19034, US

(73) Assignee: TSUBAKIMOTO CHAIN CO., OSAKA (JP)

(21) Appl. No.: 12/819,321

(22) Filed: Jun. 21, 2010

(30) Foreign Application Priority Data
Jul. 7, 2009 (JP) 2009 160752

(51) Int. Cl. F16G 13/07

(52) U.S. Cl. 474/213

(57) ABSTRACT

In silent chain transmission comprising a chain composed of rows of link plates connected in articulating relationship by connecting pins, at least one sprocket is provided with a pair of flanges that guide the chain by engaging sprocket-engaging teeth on the outermost plates of the chain.

### CROSS REFERENCE TO RELATED APPLICATIONS

This application claims priority on the basis of Japanese Patent Application 2009-160752, filed Jul. 7, 2009.The disclosure of Japanese Patent Application 2009-160752 is herein incorporated by reference.

### FIELD OF THE INVENTION

The invention relates to a silent chain transmission having a chain with toothed link plates and sprockets having peripheral sprocket teeth for engagement by the teeth of the chain to transmit power. The silent chain transmission has utility in various mechanisms, including, for example, an engine timing transmission in which power is transmitted through a timing chain from an engine crankshaft to one or more valve-operating camshafts.

### BACKGROUND OF THE INVENTION

A known silent chain transmission typically comprises a chain and at least two sprockets. The chain comprises first and second sets of link rows, each link row comprising at least one link plate. The sets of link rows are arranged in alternating, interleaved relationship, and each link plate has a front pin hole and a rear pin hole. The chain also includes a set of connecting pins, each pin extending though the rear pin holes of each link plate of a link row of the first set and through a front pin hole of each link plate of an interleaved link row of the second set. The pins connect the link rows in articulating relationship so that the link rows and connecting pins form an endless transmission chain. At least some of the link plates have sprocket-engaging plate teeth.

Each sprocket comprises a sprocket body, and sprocket teeth, formed on an outer peripheral surface and extending radially outward therefrom, for engaging sprocket-engaging plate teeth of the chain in driving or driven relationship. The silent chain transmission system transmits rotation by engaging the plate teeth with the sprocket teeth as disclosed in U.S. Patent Application Publication 2002/0132690, published on Sep. 19, 2002.

In the known silent chain transmission the plate teeth of the chain are prevented from becoming disengaged from the sprocket teeth by lateral movement relative to the direction of chain travel by forming the link plates at the outermost sides of the chain as guide plates having no teeth. These guide plates engage the opposite ends of the sprocket teeth and thereby keep the chain aligned with the sprocket.

In the known silent chain transmission, as illustrated in FIGS. 17 through 19, a chain 920 is composed of outer rows 930 composed of plates each having a pair of front and rear pin holes 933 (FIG. 17) arranged in alternating relationship with inner link rows, composed of link plates 942, each having a pair of front and rear pin holes 943. The rows are connected by connecting pins 921 fitted to the outer link rows, and hollow cylindrical bushings 922 which are fitted to the inner link rows and receive the connecting pins.

The link plates 930 of the outer link row are composed of guide plates 931 on the outermost sides in the chain, toothed link plates 932 positioned at the inner sides of the guide plates and having plate teeth 934 (FIG. 18). Each of the outer link rows is constructed by inserting connecting pin 921 through the pin holes 933 of the toothed link plates 932 and press-fitting the pins to the pin holes 933 of the guide plates 931.

The link plates of the inner link rows are composed of a plurality of inner link plates 942, all having teeth 944 (FIG. 18), and each of the inner link rows is constructed by press-fitting hollow cylindrical bushings 922 into bushing holes 943 of the inner link plates 942. The chain 920 is in the form of an endless loop in which connecting pins 921 of the outer link rows extend rotatably through hollow, cylindrical bushings 922 of inner link rows

As shown in FIG. 19, a sprocket 910 has sprocket teeth 911 on its outer peripheral surface, which engage teeth 934 and 944 of the outer and inner link plates 932 and 942 of the chain 920.

As shown in FIG. 19, the guide plates 931 of the chain 920 are positioned on the outside of the sprocket adjacent opposite ends of the sprocket teeth 911, so that they can engage the ends of the sprocket teeth and prevent the teeth 934 and 944 of the chain from being disengaged from the sprocket teeth 911 by limiting movement of the chain in directions transverse to the direction of travel of the chain 920.

The ends of the sprocket teeth 911 are chamfered to form smoothly curved end faces on the teeth so that the guide plates 931 can smoothly approach the sides of the sprocket teeth 911 as the chain 920 comes into engagement with the sprocket.

In the above-described known silent chain transmission, the guide plates 931 do not contribute to the transmission of power between the sprockets and the chain, and, because they are located at both of the widthwise outermost sides of the chain, the chain becomes wider, and occupies an excessive amount of space.

The lengths of the connecting pins, which extend into or beyond the pin holes of the outermost guide plates of the known silent chain, are at least as great as the widths of the guide rows of the chain, and are subject to considerable bending when the chain is under tension. Bending of the connecting pins results in concentration of pressure where the outer peripheral surfaces of the connecting pins abut with the inner peripheral surfaces of the bushings. Consequently, it is not possible to maintain a uniform gap between the connecting pins and the bushings, and abrasion, vibration and noise occur in the operation of the chain.

The use of guide plates requires a large number of parts and makes assembly of the chain difficult and time-consuming and contributes to the overall weight of the chain.

The use of guide plates and the need for long connecting pins also impair the ability of the chain transmission to respond to changes in speed.

### SUMMARY OF THE INVENTION

The silent chain transmission according to the invention comprises a chain and at least two sprockets. The chain comprises first and second sets of link rows, each link row comprising at least one link plate. The sets of link rows are in alternating, interleaved relationship, and each link plate has a front pin hole and a rear pin hole. The chain also includes a set of connecting pins, each pin extending though the rear pin holes of each link plate of a link row of the first set and through a front pin hole of each link plate of an interleaved link row of the second set. The pins connect the link rows in articulating relationship so that the link rows and connecting pins form an endless transmission chain. At least some of the link plates have sprocket-engaging plate teeth.

At least one of the sprockets comprises a sprocket body having an axis of rotation and sprocket teeth, formed on an outer peripheral surface and extending radially outward therefrom, for engaging sprocket-engaging plate teeth of the chain in driving or driven relationship. The sprocket teeth have first and second axially spaced ends. The widthwise outermost plates of the chain have sprocket-engaging plate teeth. Flanges are provided on each sprocket body. The flanges are disposed adjacent both ends of the sprocket teeth and extend radially outward from the outer peripheral surface of the sprocket. The flanges are engageable by sprocket-engaging plate teeth on the widthwise outermost plates of the chain for guiding the chain, whereby the chain is maintained in alignment with the sprocket.

It is unnecessary to provide the chain with guide plates to prevent the teeth of the chain from disengaging from the sprocket teeth, and unnecessary to make the width of the chain greater than the axial lengths of the sprocket teeth. Accordingly, it becomes possible to reduce the width of the chain, to reduce the number of parts, and to reduce the overall weight of the chain. It also becomes possible to reduce the space occupied by the chain, to reduce abrasion, vibration and noises, to facilitate assembly of the chain, and to improve the ability of the chain to follow changes in operating speed.

In a preferred embodiment of the invention, all of the link plates of the first and second sets of link rows have plate teeth. In this case all of the link plates are directly involved in the transmission of power, and it is possible to reduce the width of the chain and its weight. Consequently it becomes possible to achieve further reduction in the weight and width of the chain, to achieve further reduction in abrasion, vibration and noise, and to achieve further improvement in the ability of the chain to follow changes in operating speed.

Each connecting pin can be press-fit into pin holes of link plates located on the widthwise outermost sides of said chain. It becomes unnecessary to make the width of the chain greater than the lengths of the sprocket teeth and unnecessary to provide additional structural members such as plates for fixing the connecting pins on the outermost sides of the chain. The absence of additional structural parts also contributes reduction in the weight and width of the chain, to reduction in abrasion, vibration and noise, and to further improvement in the ability of the chain to follow changes in operating speed.

Hollow cylindrical bushing can be fitted into pin holes of the link plates of one of the first and second sets of link rows, connecting pins can be fitted to pin holes of the other set of link rows, and each of the connecting pins can extend rotatably through one of the bushings. The outer peripheral surfaces of the connecting pins and the inner peripheral surfaces of the bushings become the relatively sliding parts of the chain during flexion of the chain, so that it becomes possible to achieve further reduction in abrasion, vibration and noise. Moreover, the bushing makes it possible to provide gaps between the first and second link rows so that the link plates of the first link rows do not directly slide on the link plates of the second link rows, and flexion resistance can be reduced.

In an embodiment of the silent chain transmission, the diameter of each flange on at least one of the sprockets can be greater than the diameter of a circle tangent to the tips of the teeth on the sprocket but less than the diameter of an inscribed circle tangent to the connecting pins on a portion of the chain seated on that sprocket. In this case, the flanges will not collide with the connecting pins, and the thickness and weight of the sprocket can be reduced by making the flanges only thick enough that they can function to guide the chain. In this say it is possible to reduce the space occupied by the sprocket and to improve the ability of the chain transmission to follow changes in speed.

In another embodiment, the diameter of each flange on at least one sprocket can be smaller than the diameter of a circle tangent to the tips of the sprocket teeth but greater than the diameter of a circle tangent to the tips of the teeth on a portion of the chain seated on the sprockets. Here, the weight of the sprocket can be reduced by reducing the diameters of the flanges to the diameter required for the flanges to function as guides. Again, by making the flanges only large enough to function as guides, it becomes possible to reduce the size of the sprocket and to improve the ability of the transmission to follow changes in speed.

In still another embodiment, where connecting pins extend beyond the widthwise outermost plates of the chain, the diameter of each flange on at a sprocket can be is greater than the diameter of an inscribed circle tangent to the connecting pins on a portion of the chain seated on the sprocket. In this case, the portion of each flange that extends radially outward beyond the inscribed circle can be formed with a recess for receiving the connecting pins without contacting the connecting pins. In this embodiment it is also possible to prevent the flanges from colliding with the connecting pins, to enhance the ability of the flanges to serve as guides, and more reliably prevent the chain from becoming disengaged from the sprocket.

In still another embodiment, each flange on at least one of the sprockets can have a wave-shaped profile having alternating peaks and troughs shaped so that portions of the sides of the sprocket teeth are exposed through the troughs, and so that portions of the chain disposed between said sprocket teeth are covered by the peaks of the flanges. Adoption of flanges having a wave-shaped profile enables the weight of the sprocket to be reduced without sacrificing the ability of the flanges to serve reliably as guide. By reducing weight, the wave-shaped profiles also improve the ability of the transmission to follow changes in speed.

The flanges on a sprocket may be connected directly to mounting shaft on which the sprocket is mounted so that the sprocket body is interposed between the flanges. In this case, the flanges can be formed of a light-weight material different from the material of the sprocket body, and the overall weight of the sprocket can be reduced. The use of flanges connected directly to the mounting shaft can also make it possible to reduce occupied space, to improve the ability of the transmission to follow changes of speed, to facilitate mounting of the sprocket body, and other assembly steps.

Alternatively, the flanges can be mounted on stepped recesses formed on both sides the sprocket body. In this case, the flanges can be rigidly fixed to the sprocket body to enhance their strength as guides. Mounting the flanges on the sprocket body can also facilitate assembly of the sprocket.

### BRIEF DESCRIPTION OF DRAWINGS

FIG. 1 is a schematic elevational view of a silent chain transmission according the invention;

FIG. 2 is a perspective view of a sprocket and a portion of a chain in a silent chain transmission according to an embodiment of the invention;

FIG. 3 is a plan view of a portion of a chain of the silent chain transmission according to a first embodiment of the invention;

FIG. 4 is a side elevational view of the chain in FIG. 3;

FIG. 5 is a plan view of a portion of a chain of a silent chain transmission according to a second embodiment of the invention;

FIG. 6 is a plan view of a chain of a silent chain transmission according to a third embodiment of the invention;

FIG. 7 is a side elevational view of the chain in FIG. 6;

FIG. 8 is a side elevational view of a sprocket and a portion of a chain of the silent chain transmission system according to a fourth embodiment of the invention;

FIG. 9 is an end elevational view, partly in section of the sprocket and chain in FIG. 8;

FIG. 10 is a side elevational view of a sprocket and a portion of a chain of the silent chain transmission system according to a fifth embodiment of the invention;

FIG. 11 is an end elevational view, partly in section of the sprocket and chain in FIG. 10;

FIG. 12 is a side elevational view of a sprocket and a portion of a chain of the silent chain transmission system according to a sixth embodiment of the invention;

FIG. 13 is an end elevational view, partly in section of the sprocket and chain in FIG. 12;

FIG. 14 is a side elevational view of a sprocket and a portion of a chain of the silent chain transmission system according to a seventh embodiment of the invention;

FIG. 15 is an end elevational view, partly in section, of the sprocket and chain in FIG. 14;

FIG. 16 is a side elevational view of a sprocket of the silent chain transmission system according to an eighth embodiment of the invention;

FIG. 17 is a plan view of a chain of a prior art silent chain transmission;

FIG. 18 is a side elevational view of a portion of the chain of FIG. 17; and

FIG. 19 is perspective view of a sprocket and a portion of a chain in a silent chain transmission prior art silent chain transmission.

### DETAILED DESCRIPTION OF THE PREFERRED EMBODIMENTS

The silent chain transmission of the invention can be embodied in any of a large number of embodiments. In each case, the silent chain transmission preferably comprises a chain and at least two sprockets. The chain comprises first and second sets of link rows, each link row comprising at least one link plate. The sets of link rows are in alternating, interleaved relationship, and each link plate has a front pin hole and a rear pin hole. The chain also includes a set of connecting pins, each pin extending though the rear pin holes of each link plate of a link row of the first set and through a front pin hole of each link plate of an interleaved link row of the second set. The pins connect the link rows in articulating relationship so that the link rows and connecting pins form an endless transmission chain. At least some of the link plates have sprocket-engaging plate teeth.

Each sprocket comprises a sprocket body having an axis of rotation and sprocket teeth, formed on an outer peripheral surface and extending radially outward therefrom, for engaging sprocket-engaging plate teeth of the chain in driving or driven relationship. The sprocket teeth have first and second axially spaced ends. The widthwise outermost plates of the chain have sprocket-engaging plate teeth. Flanges are provided on each sprocket body, are disposed adjacent both ends of the sprocket teeth, and extend radially outward from the outer peripheral surface of the sprocket. The flanges are engageable by sprocket-engaging plate teeth on the widthwise outermost plates of the chain, for guiding the chain and maintaining the chain in alignment with the sprocket.

It is unnecessary to provide the chain with guide plates to prevent the teeth of the chain from disengaging from the sprocket teeth, and unnecessary to make the width of the chain greater than the axial lengths of the sprocket teeth. Accordingly, it becomes possible to reduce the width of the chain, to reduce the number of parts, and to reduce the overall weight of the chain. It also becomes possible to reduce the space occupied by the chain, to reduce abrasion, vibration and noises, to facilitate assembly of the chain, and to improve the ability of the chain to follow changes in operating speed.

The flanges of the sprocket of the silent chain transmission may be attached directly to the sprocket body or directly to the shaft on which the sprocket body is mounted. The flanges can be composed of any of various materials such as metals, resins, ceramics and the like, as long as the material exhibits adequate abrasion resistance when contacted by the transmission chain and sufficient strength to function as a guide for the chain.

Specifically, a light-weight material capable of exhibiting a smooth guiding function and durability in a high-temperature environment can be suitable. Examples of suitable synthetic resins include polyamide 6 resin, polyamide 46 resin, polyamide 66 resin, polyacetal resins, and the like.

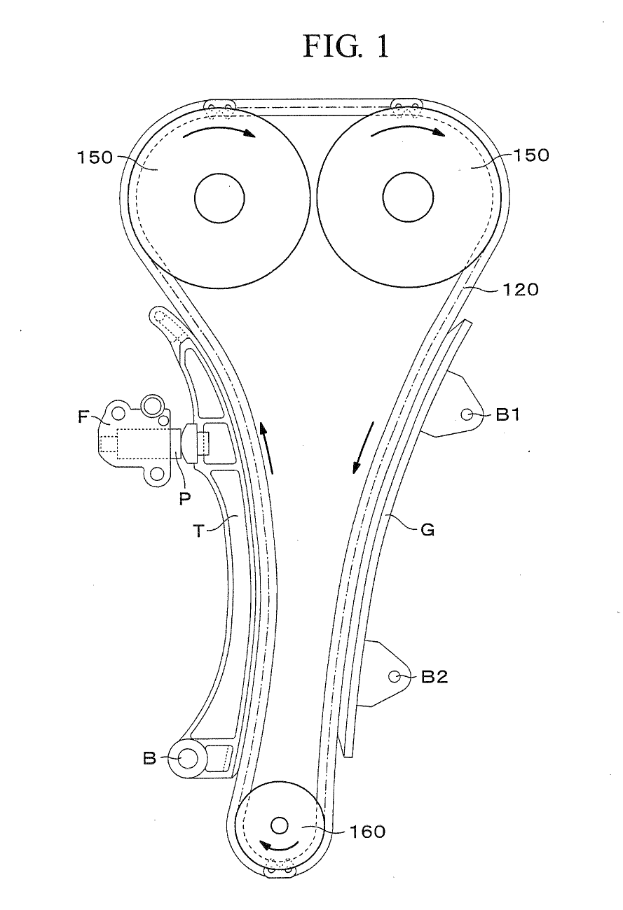

As shown in FIG. 1, an engine timing system incorporating a silent chain transmission according to the invention includes a chain 120 in driven engagement with driving sprocket 160 mounted on an engine crankshaft, and in driving engagement with a pair of driven sprockets 150 mounted respectively on engine camshafts. A tensioner lever T guides and maintains adequate tension in the portion of chain 120 traveling from sprocket 160 toward one of sprockets 150. Tensioner lever T is pivoted on a shaft B fixed to an engine block (not shown), and is biased against the chain by a plunger P within a tensioner housing F also fixed to the engine block. A fixed guide member G, that guides the portion of the chain traveling from the other camshaft sprocket 150 toward the crankshaft sprocket 160, is fixed to the engine block by fasteners B1 and B2.

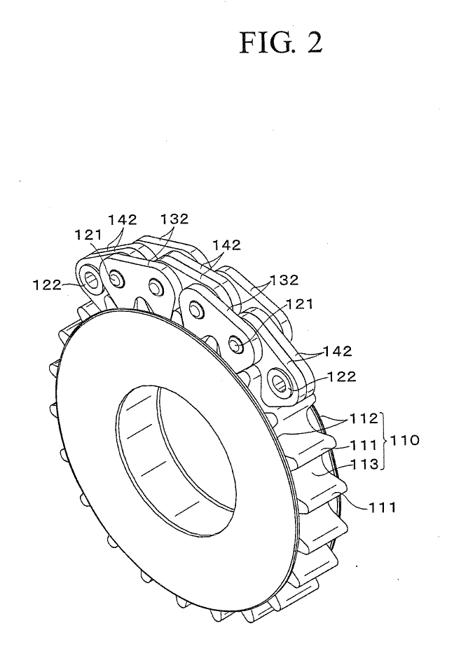

As shown in FIGS. 2 through 4, the silent chain transmission system of a first embodiment of the invention includes a chain 120 that is composed of alternating outer, or first, link rows and inner, or second, link rows, connected by connecting pins 121 and bushings 122, and a sprocket 110. The sprocket can be a driven sprocket 150 (FIG. 1) or a driving sprocket 160 (FIG. 1), and has a sprocket body 113 (FIG. 2) provided with sprocket teeth 111 on it outer peripheral surface thereof and flanges 112 on both sides of the sprocket body and extending outwardly at least beyond the roots of the sprocket teeth 11, for guiding the chain 120.

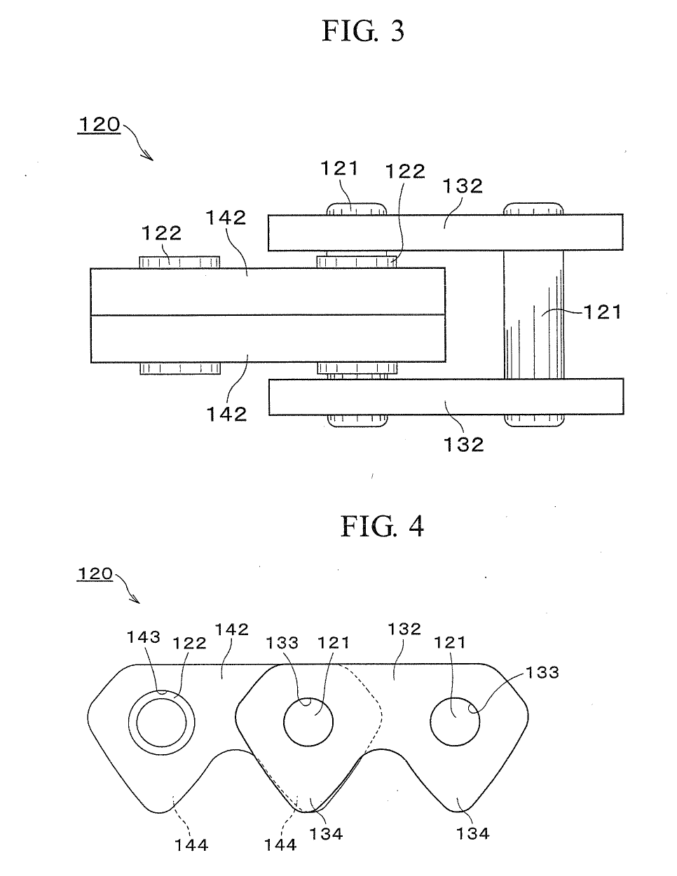

As shown in FIGS. 3 and 4, the chain 120 includes outer (first) link rows the first link rows, each composed of a pair of outer link plates 132 each having a pair of front and rear pin holes 133, and inner (second) link rows, each composed of a pair of inner link plates 142, each having a pair of front and rear bushing holes 143.

Each of the outer link plates 132 of the outer link row is provided with plate teeth 134 and the connecting pins 121 are inserted through, and press-fit into, the pin holes 133 of the outer link plates 132. The inner link plates 142 of the inner link row is also provided with plate teeth 144. Hollow cylindrical bushings 122 are press-fit into to the bushing holes 143 of the inner link plates 142. The inner link plates 142 contact each other. The chain 120 is assembled into a flexible, endless loop by fitting the connecting pins 121 of the outer link rows rotatably into hollow cylindrical bushings 122 of the inner link rows.

The transmission system is arranged to transmit power rotations by engaging the plate teeth 134 and 144 of the outer and inner link plates 132 and 142 with the sprocket teeth 111 of sprockets 110.

The flanges 112 of the sprocket 110 are provided on the outside ends of the sprocket teeth 111, so that the widthwise movement of the outer link plates 132 is restricted. The plate teeth 134 and 144 are thereby prevented from disengaging from the sprocket teeth 111.

One or more driving or driven sprockets in a transmission, e.g., sprockets 160 and 150 in FIG. 1, can be in the form of sprocket 110, having flanges 112. It is also possible for the transmission to include one or more sprockets having no flanges. Because the flanges on the sprocket or sprockets make it unnecessary to provide guide plates on the outsides of the outer link plates 132, i.e., on the outermost sides of the chain 120 for preventing disengagement of the chain from a sprocket, it is possible to reduce the width of the chain 120, to reduce the number of parts, and to reduce the overall weight of the chain 120. Accordingly, it also becomes possible to reduce the space occupied by the transmission, to reduce abrasion, vibration and noise, to facilitate the assembly of the chain, and to improve the ability of the chain to follow changes in speed.

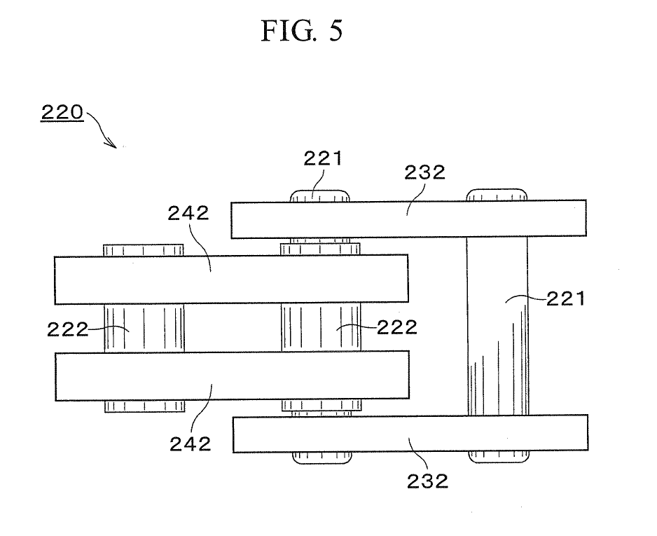

In the second embodiment as shown in FIG. 5, in a chain 220 hollow cylindrical bushings 222 are press-fit into bushing holes of inner link plates 242, and the inner link plates 242 are spaced apart from each other. Otherwise, the structure and operation of the second embodiment are substantially the same as the structure and operation of the first embodiment.

Because it is unnecessary to provide guide plates 232 on the outsides of the outer link plates of the chain, i.e., on the outermost sides of the chain 220, the number of link plates is reduced. Noise and vibration are also reduced reducing bending of the connecting pins and assuring more uniform sliding contact between the connecting pins 221 and the bushings 222, thereby reducing surface pressure. The elimination of guide plates reduces the width of the chain 120, and reduces the number of parts, and the overall weight of the chain 220. Accordingly, it also becomes possible to reduce the space occupied by the transmission, to reduce abrasion, vibration and noise, to facilitate the assembly of the chain, and to improve the ability of the chain to follow changes in speed.

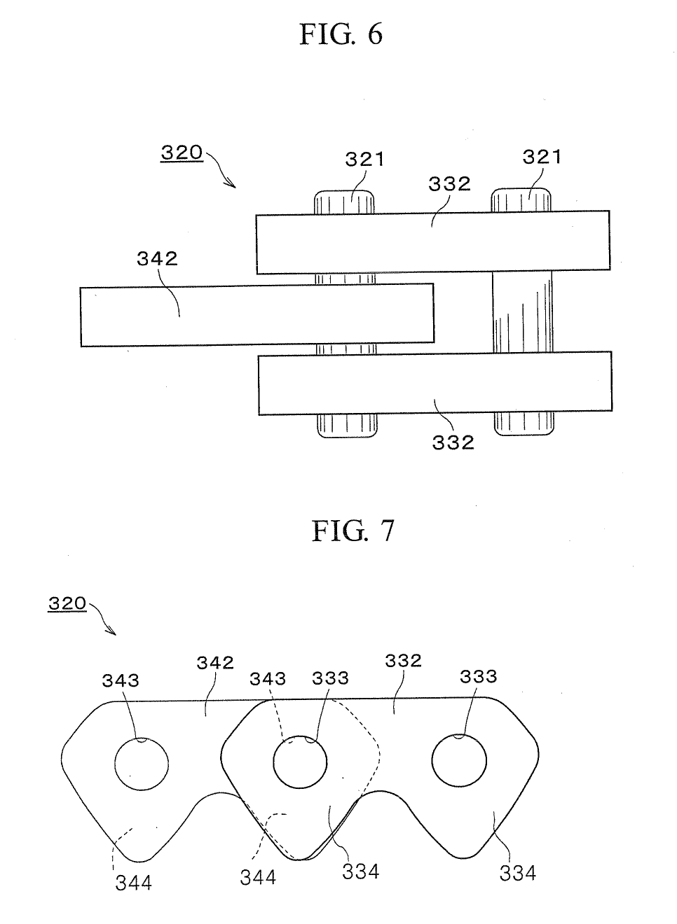

As shown in FIGS. 6 and 7, a silent chain transmission 300 according to a third embodiment of the invention comprises a chain 320 whose outer, or first, link rows are flexibly connected to inner, or second, link rows. Each outer link row comprises a pair of outer link plates 332 having pin holes 333, and each inner link row consists of a single link plate 342 having pin holes 343. The outer link plates are connected by connecting pins 321, which are press-fit into holes 333 and extend rotatably through pin holes 343 in the inner link plates. The chain cooperates with a sprocket (not shown but similar to the sprocket in FIG. 2) having a sprocket body provided with sprocket teeth around the outer peripheral surface thereof and flanges on both sides for guiding the chain.

Except as described above, the structure and operation of the silent chain transmission of the third embodiment are substantially the same as the structure and operation of the first embodiment.

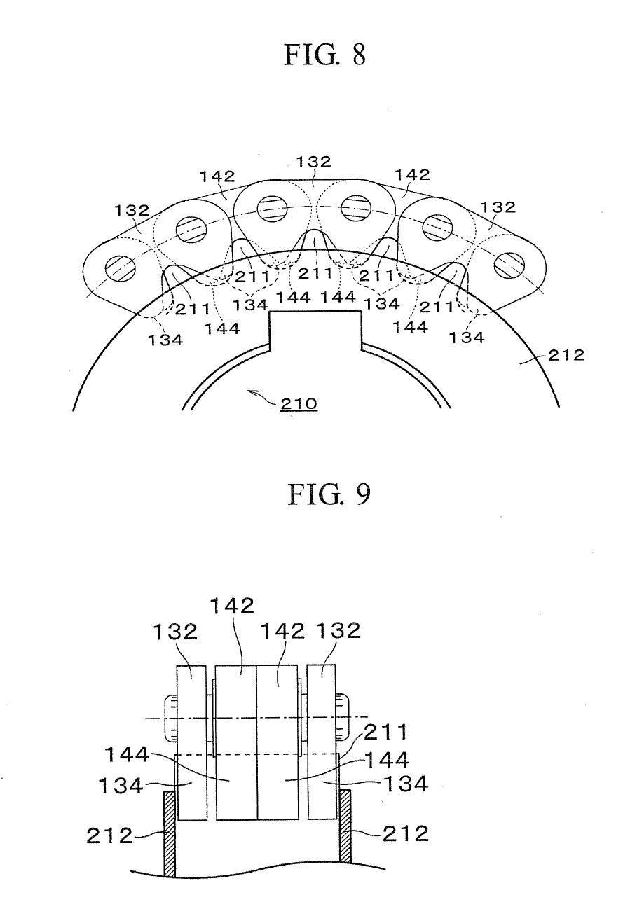

As shown in FIGS. 8 and 9, a sprocket 210 of a silent chain transmission according to a fourth embodiment of the invention transmits power by engagement of its sprocket teeth 211 with the plate teeth 134 and 144 of the outer and inner link plates 132 and 142 of a chain 120.

Both sides of the sprocket 210 are provided with flanges 212 which extend beyond the roots of sprocket teeth 211 but not beyond their tips. That is, the diameter of each of flanges 212 is smaller than the diameter of an imaginary circle tangent to the tips of the sprocket teeth and centered on the axis of rotation of the sprocket. On the other hand, the diameter of each the flanges is greater than that of an imaginary circle tangent to the tips of the outer plate teeth 134 in a portion of the chain seated on the sprocket. Accordingly, widthwise movement of the outer link plates 132 is restricted to prevent the plate teeth 134 and 144 from disengaging from the sprocket teeth 111 by widthwise movement of the chain.

Because the overall weight of the sprocket 210 can be reduced by reducing the diameters of the flanges 212 to a diameter no greater than that necessary to enable the flanges to function as a guide, it is possible to reduce the overall weight of the silent chain transmission and also to improve its ability to follow changes of speed.

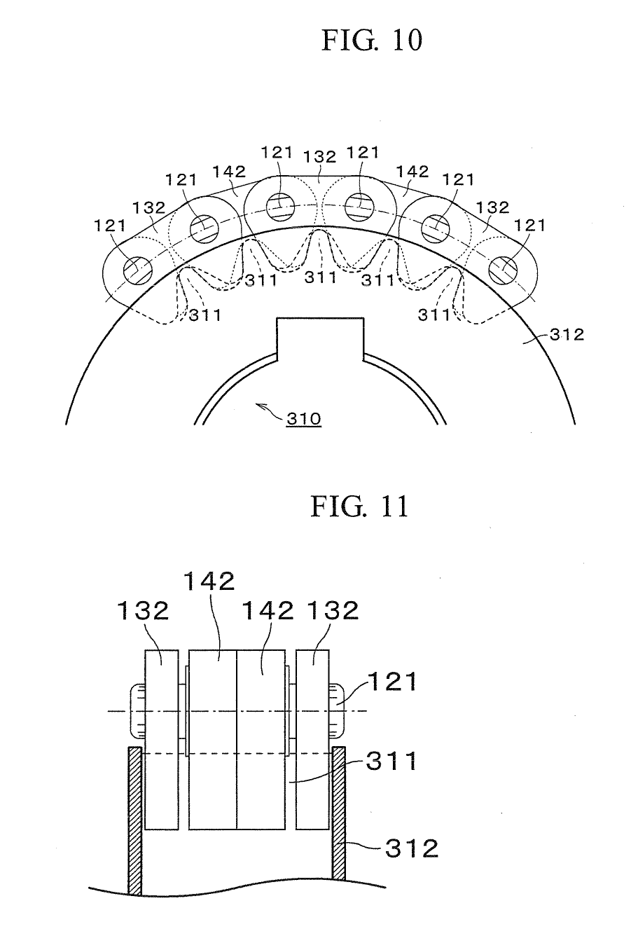

In a fifth embodiment, shown in FIGS. 10 and 11, a sprocket 310 transmits power by engagement of its teeth 311 with the plate teeth of the outer and inner link plates 132 and 142 of a chain.

Flanges 312 are provided on both sides of sprocket 310 at the opposite ends of sprocket teeth 311. The flanges 312 have a diameter larger than that of an imaginary circle tangent to the tips of the sprocket teeth and centered on the axis of rotation of the sprocket, but smaller than the diameter of an inscribed circle tangent to the connecting pins 121 of portions of the chain seated on the sprocket. Accordingly, widthwise movement of the outer link plates 132 is restricted to prevent the plate teeth 134 and 144 from disengaging from the sprocket teeth 311, but the flanges 312 cannot collide with the ends of the connecting pins 121.

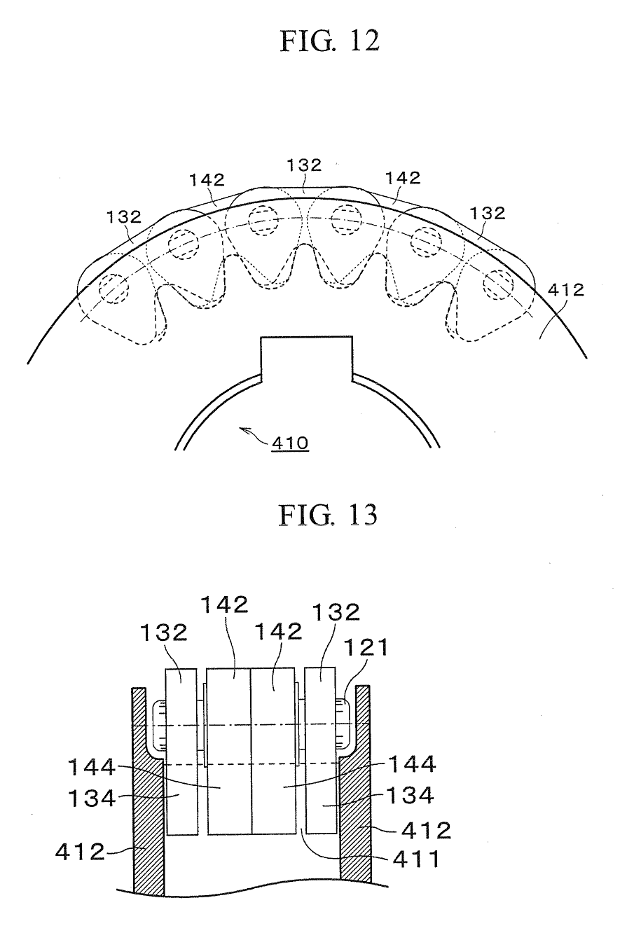

As shown in FIGS. 12 and 13, a sprocket 410 is arranged to transmit power by engagement of sprocket teeth 411 with plate teeth 134 and 144 of outer and inner link plates 132 and 142 of the chain 120.

The sprocket 410 is provided with flanges 412 on the ends of the sprocket teeth 411. The diameter of flanges 412 is such that the flanges extend to or beyond the ends of the connecting pins 121. The widthwise movement of the outer link plates 132 is restricted in order to prevent the plate teeth 134 and 144 from disengaging from the sprocket teeth 111.

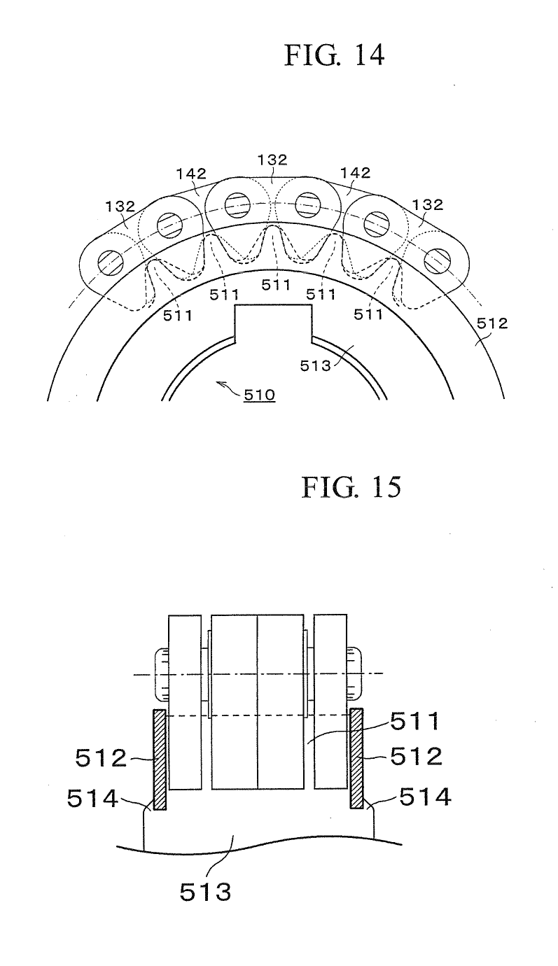

As shown in FIGS. 14 and 15, a sprocket 510 of the silent chain transmission system of a seventh embodiment of the invention is arranged to transmit power by engagement of the sprocket teeth 511 with the plate teeth 134 and 144 of the outer and inner link plates 132 and 142 of the chain 120.

Because flanges 512 are fixed to stepped portions 514 provided on both sides of a sprocket body 513, widthwise movement of the outer link plates 132 is restricted to prevent the plate teeth 134 and 144 from disengaging from the sprocket teeth 111.

It is therefore possible to fix the flanges 512 rigidly to the sprocket body 513, to strengthen the flanges, and to handle flanges together with the sprocket body 513, so that assembly of the sprocket can be facilitated.

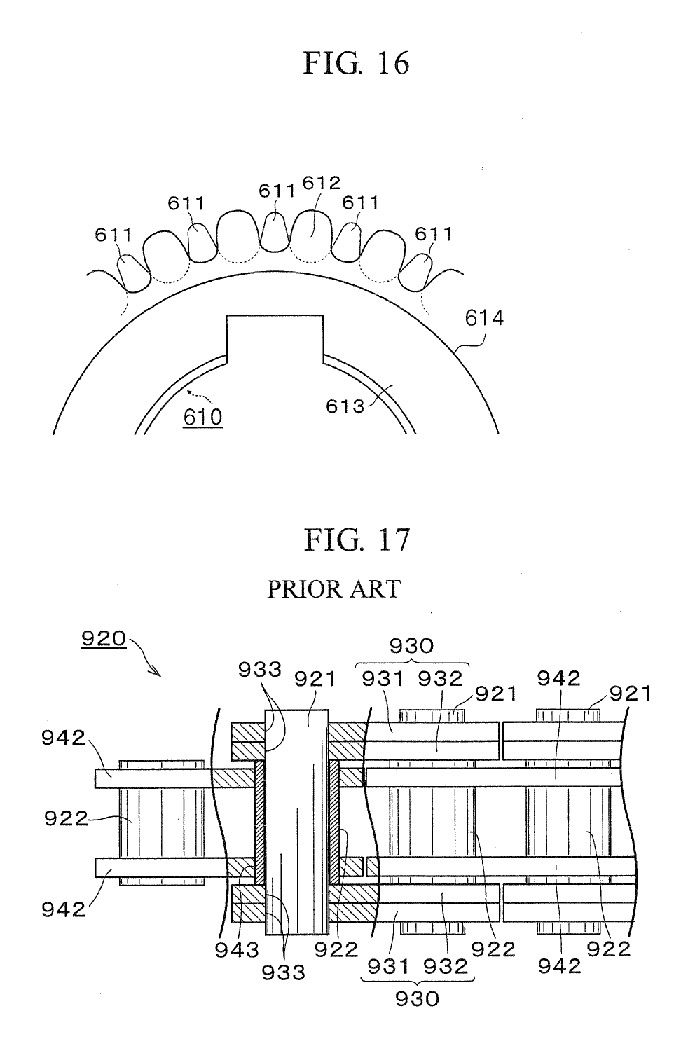

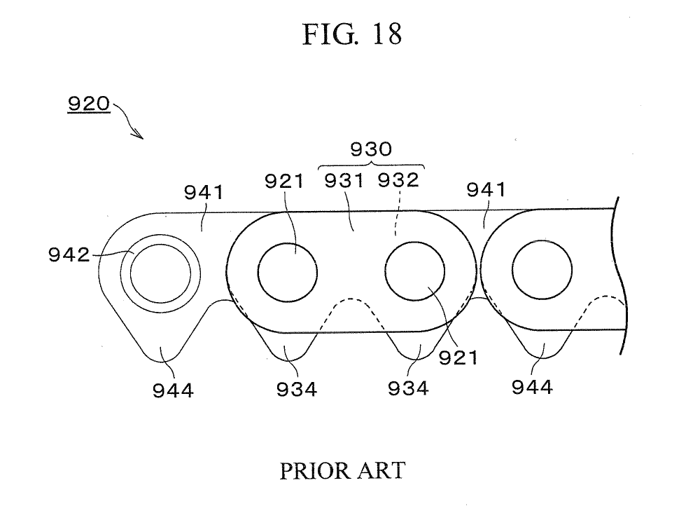

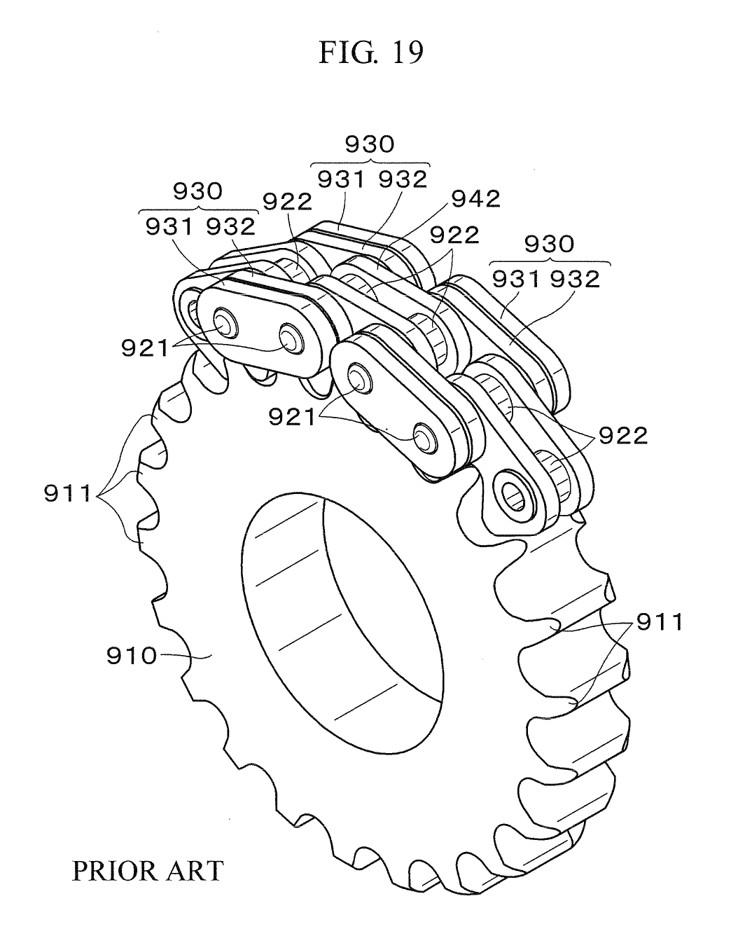

As shown in FIG. 16, a sprocket 610 of a silent chain transmission according to an eighth embodiment of the invention is provided with flanges 612 on the ends of sprocket teeth 611. The flanges are fitted into stepped portions 614 provided on both sides of a sprocket body 613, and the flanges 612 have a wave-shaped profile that exposes side surfaces of the sprocket teeth 611, and covers parts of the side surfaces of the outer link plate teeth located between the adjoining sprocket teeth 611.

Because the wave-shaped profile makes it possible to reduce the weight of the sprocket 610 while maintaining the height and strength of the parts of the flange that serve as a guide, the overall weight of the silent chain transmission can be reduced, and its ability to follow speed changes can be improved.

Because it is unnecessary to provide guide plates on the outsides of the chain to prevent the teeth of the chain from disengaging from the sprocket teeth, it is possible to reduce the width of the chain, to reduce the number of its parts, and to reduce the weight of the chain. Accordingly, the silent chain transmission of the invention has remarkable advantages, especially in that it is possible to reduce the space occupied by the chain transmission, to reduce abrasion, vibrations and noise, to facilitate assembly of the chain by reducing the number of parts, and to improve the ability of the chain to follow speed changes.

What is claimed is:

1. A silent chain transmission comprising:
a chain comprising first and second sets of link rows, each link row comprising at least one link plate, the sets of link rows being in alternating, interleaved relationship, each link plate having a front pin hole and a rear pin hole, and a set of connecting pins, each said pin extending though the rear pin holes of each link plate of a link row of the first set and through a front pin hole of each link plate of an interleaved link row of the second set, whereby the link rows are connected in articulating relationship and form an endless transmission chain, at least some of said link plates having sprocket-engaging plate teeth for engagement with sprocket teeth;
a plurality of sprockets, at least one of the sprockets comprising a sprocket body having an axis of rotation, an outer peripheral surface, and sprocket teeth formed on said outer peripheral surface and extending radially outward therefrom, for engaging sprocket-engaging plate teeth of the chain in driving or driven relationship, the sprocket teeth having first and second axially spaced ends;
wherein the widthwise outermost plates of the chain have sprocket-engaging plate teeth; and
wherein flanges are provided on said sprocket body, said flanges being disposed adjacent both ends of the sprocket teeth and extending radially outward from said outer peripheral surface of the sprocket, said flanges being engageable by sprocket-engaging plate teeth on the widthwise outermost plates of the chain for guiding the chain whereby the chain is maintained in alignment with the sprocket.

2. The silent chain transmission according to claim 1, wherein all of the link plates of said first and second sets of link rows have plate teeth.

3. The silent chain transmission according to claim 1, wherein each said connecting pin is press-fit into pin holes of link plates located on the widthwise outermost sides of said chain.

4. The silent chain transmission according to claim 1, wherein hollow cylindrical bushing are fitted into pin holes of the link plates of one of said first and second sets of link rows, connecting pins are fitted to pin holes of the other of said first and second sets of link rows, and each of said connecting pins extends rotatably through one of said bushings.

5. The silent chain transmission according to claim 1, wherein the diameter of each said flange on at least one of said sprockets is greater than the diameter of a circle tangent to the tips of the teeth on said one of said sprockets but less than the diameter of an inscribed circle tangent to the connecting pins on a portion of the chain seated on said one of said sprockets.

6. The silent chain transmission according to claim 1, wherein the diameter of each said flange on at least one of said sprockets is smaller than the diameter of a circle tangent to the tips of the teeth on said one of said sprockets but greater than the diameter of a circle tangent to the tips of the teeth on a portion of the chain seated on said one of said sprockets.

7. The silent chain transmission according to claim 1, wherein the connecting pins extend beyond the widthwise outermost plates of the chain, wherein the diameter of each said flange on at least one of said sprockets is greater than the diameter of an inscribed circle tangent to the connecting pins on a portion of the chain seated on said one of said sprockets, and wherein the portion of each said flange on said at least one of said sprockets that extends radially outward beyond said inscribed circle is formed with a recess for receiving the connecting pins without contacting said connecting pins.

8. The silent chain transmission according to claim 1, wherein each flange on at least one of said sprockets has a wave-shaped profile having alternating peaks and troughs shaped so that portions of the sides of the sprocket teeth are exposed through said troughs, and so that portions of the chain disposed between said sprocket teeth are covered by said peaks.

9. The silent chain transmission according to claim 1, wherein the flanges on said at least one of said sprockets are connected directly to mounting shaft on which said at least one of said sprockets is mounted and the sprocket body is interposed between said flanges.

10. The silent chain transmission according to claim 1, wherein the flanges on said at least one of said sprockets are mounted on stepped recesses formed on both sides of the sprocket body of at said at least one sprocket.
